(19) United States
(12) Patent Application Publication
(10) Pub. No.: US 2015/0149755 A1
(43) Pub. Date: May 28, 2015

(54) PROJECTOR AND BOOT UP METHOD THEREOF

(71) Applicant: DELTA ELECTRONICS, INC., Taoyuan Hsien (TW)

(72) Inventor: Yuan-Ming HSU, Taoyuan Hsien (TW)

(73) Assignee: DELATA ELECTRONICS, INC., Taoyuan Hsien (TW)

(21) Appl. No.: 14/278,585

(22) Filed: May 15, 2014

(30) Foreign Application Priority Data
Nov. 27, 2013 (TW) 102143151

(51) Int. Cl. G06F 21/88; G06F 21/57; G06F 21/30; G06F 9/44

(52) U.S. Cl. CPC G06F 21/88; G06F 9/4401; G06F 21/575; G06F 21/30
USPC 713/2

(57) ABSTRACT

A projector comprises an environment detecting module and a processing module. The environment detecting module detects a predetermined environmental information at a first time and a real-time environmental information at a second time. The processing module is coupled to the environment detecting module, receives the predetermined environmental information and the real-time environmental information and executes a boot up method. The boot up method includes the steps of: storing and defining the predetermined environmental information as a comparison reference; and comparing the predetermined environmental information with the real-time environmental information, wherein when the predetermined environmental information and the real-time environmental information are substantially the same, a boot up program is executed, and when the predetermined environmental information and the real-time environmental information are substantially different, an authorization command request is outputted. A boot up method of a projector is also disclosed.

### CROSS REFERENCE TO RELATED APPLICATIONS

This Non-provisional application claims priority under 35 U.S.C. §119(a) on Patent Application No(s). 102143151 filed in Taiwan, Republic of China on Nov. 27, 2013, the entire contents of which are hereby incorporated by reference.

### BACKGROUND OF THE INVENTION

1. Field of Invention

The invention relates to a projector and, in particular, to a boot up method of a projector.

2. Related Art

With the progress of technologies, many things in life are gradually replaced and carried out by an electronic manner. For example, an lecture occasion for a lot of people or a conference has taken place in an electronic manner. Therefore, most lecture rooms or conference rooms are configured with projectors to supply the use for the lecturer or discussants.

However, the projector is often installed in a required place, mostly a public place such as a lecture room or a conference room, so the projector will probably risk suffering loss by theft. In another case, the projector may be locked in a lockable space, such as a safe, and then moved to the lecture room or conference room when it needs to be used. However, the projector in this case will be easily damaged due to the frequent movement. Moreover, for a larger-sized lecture room, the projector is usually fixed to under the ceiling or to another proper location and locked by a chain or other locking devices to prevent theft, but this manner is not pleasing in appearance. Moreover, a current usage is further provided that the projector is used in cooperation with an authorization command (e.g. particular code), which needs to be inputted to start the projector, and therefore the theft can be prevented. However, it is really bothersome to input the authorization command for unlocking the projector every time before using the projector.

Therefore, it is an important subject to provide a projector and a boot up method thereof which are designed in a novel and simple manner to achieve the effectiveness of preventing theft, and the authorization command is unnecessary to be inputted for unlocking the projector in every use so that the user won't be bothered.

### SUMMARY OF THE INVENTION

In view of the foregoing subject, an objective of the invention is to provide a projector and a boot up method thereof which are designed in a novel and simple manner to achieve the effectiveness of preventing theft, and the authorization command is unnecessary to be inputted for unlocking the projector in every use so that the user won't be bothered.

To achieve the above objective, a projector according to the invention comprises an environment detecting module and a processing module. The environment detecting module detects a predetermined environmental information at a first time and a real-time environmental information at a second time. The processing module is coupled to the environment detecting module, receives the predetermined environmental information and the real-time environmental information and executes a boot up method. The boot up method includes the steps of: storing and defining the predetermined environmental information as a comparison reference; and comparing the predetermined environmental information with the real-time environmental information, wherein when the predetermined environmental information and the real-time environmental information are substantially the same, a boot up program is executed, and when the predetermined environmental information and the real-time environmental information are substantially different, an authorization command request is outputted.

To achieve the above objective, a boot up method of a projector according to the invention comprises the steps of: receiving a predetermined environmental information at a first time and storing and defining the predetermined environmental information as a comparison reference; and receiving a real-time environmental information at a second time and comparing the predetermined environmental information with the real-time environmental information, wherein when the predetermined environmental information and the real-time environmental information are substantially the same, a boot up program is executed, and when the predetermined environmental information and the real-time environmental information are substantially different, an authorization command request is outputted.

In one embodiment, the first time denotes the timing of the first boot-up of the projector after the projector is disposed in a particular area.

In one embodiment, the second time denotes another timing of the projector after the projector is disposed in a particular area except the timing of the first boot-up of the projector.

In one embodiment, the boot up method further includes a step of: defining a predetermined authorization command at the first time.

In one embodiment, the boot up method further includes a step of: receiving an authorization command and comparing the authorization command with the predetermined authorization command.

In one embodiment, when the authorization command and the predetermined authorization command are substantially the same as each other, the processing module executes the boot up program.

In one embodiment, when the authorization command is substantially different from the predetermined authorization command, the processing module outputs the authorization command request.

In one embodiment, the environment detecting module includes a first direction detecting unit detecting a distance between the projector and a first covering object along a first direction.

In one embodiment, the environment detecting module includes a second direction detecting unit detecting a distance between the projector and a second covering object along a second direction that is different from the first direction.

In one embodiment, the environment detecting module includes an infrared distance detecting sensor or an ultrasonic distance detecting sensor.

In one embodiment, the processing module further includes a storing unit storing the predetermined environmental information and the predetermined authorization command.

In one embodiment, the projector further includes an input module coupled with the processing module.

In one embodiment, the predetermined environmental information and the real-time environmental information include a distance between the projector and a first covering object along a first direction.

In one embodiment, the predetermined environmental information and the real-time environmental information further include a distance between the projector and a second covering object along a second direction, and the first direction is different from the second direction.

As mentioned above, in the projector and the boot up method thereof of the invention, the projector is disposed in a particular area, and the predetermined environmental information (location of the projector) is acquired at the first time of boot up (the first time) and defined as a comparison reference. Then, the real-time environmental information can be acquired at the subsequent boot up (the second time) and compared with the predetermined environmental information. If they are substantially the same, it means the projector is not moved and the boot up program can be directly executed to provide a convenient use for the user. If they are different from each other, it means the projector is moved, and an authorization command request will be outputted and the boot up program can't be executed so that the anti-theft effectiveness can be achieved.

This anti-theft manner whereby the boot up program can be directly executed when the location of the projector is not changed and the corresponding authorization command needs to be inputted only when the location is changed is convenient for the user's operation, and also eliminates the inconvenience of the conventional art where the authorization command needs to be inputted for the unlocking at every time of using the projector. Moreover, because the predetermined environmental information and the real-time environmental information are acquired by the environment detecting module of the projector, there is no need to add the component that will affect the appearance of the projector, and therefore not only the anti-theft effectiveness is achieved but also the completeness of the appearance of the projector is kept.

### BRIEF DESCRIPTION OF THE DRAWINGS

The invention will become more fully understood from the detailed description and accompanying drawings, which are given for illustration only, and thus are not limitative of the present invention, and wherein:

FIG. 1 is a schematic diagram of a projector according to an embodiment of the invention;

FIG. 2 is a schematic block diagram of the projector in FIG. 1;

FIG. 3 is a schematic diagram of the projector 1 in FIG. 1 disposed to another particular area;

FIG. 4 is a schematic flowchart of a boot up method of a projector according to an embodiment of the invention; and

FIG. 5 is a schematic flowchart of a boot up method of a projector according to another embodiment of the invention.

### DETAILED DESCRIPTION OF THE INVENTION

The present invention will be apparent from the following detailed description, which proceeds with reference to the accompanying drawings, wherein the same references relate to the same elements.

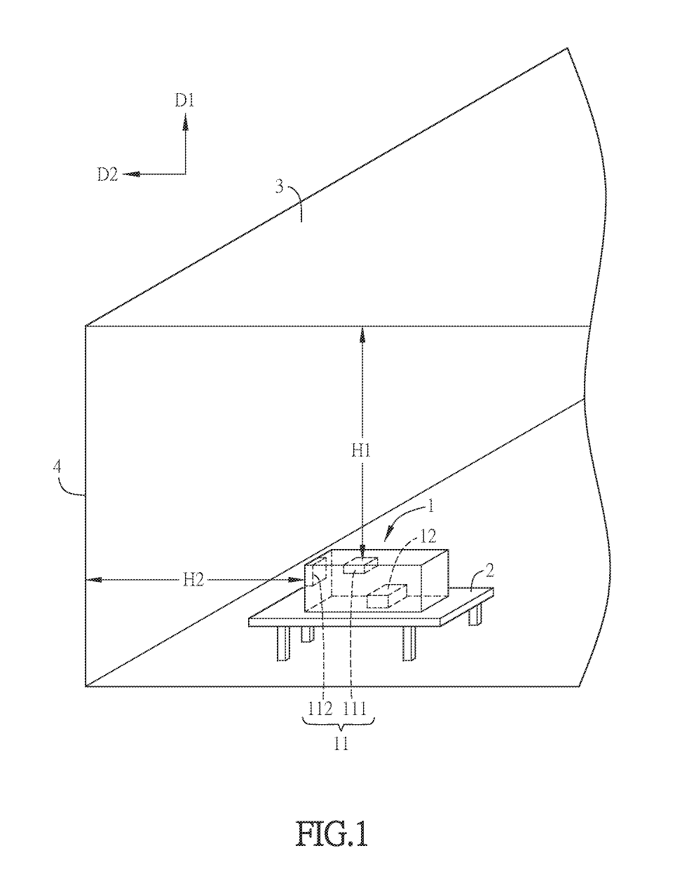

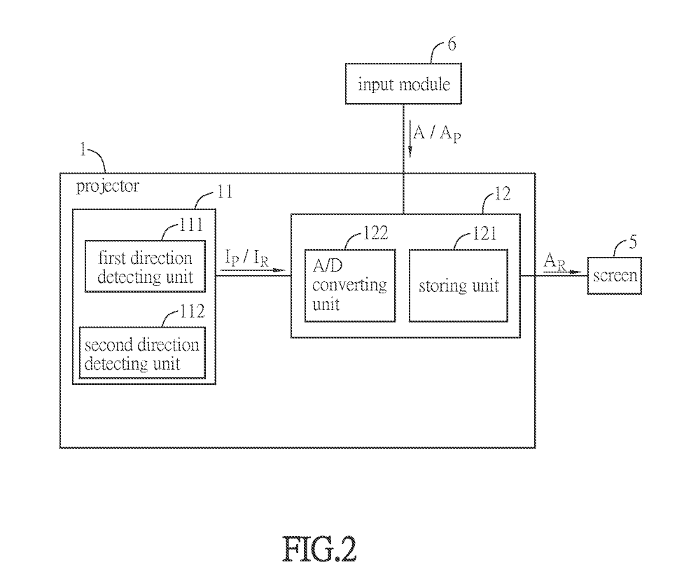

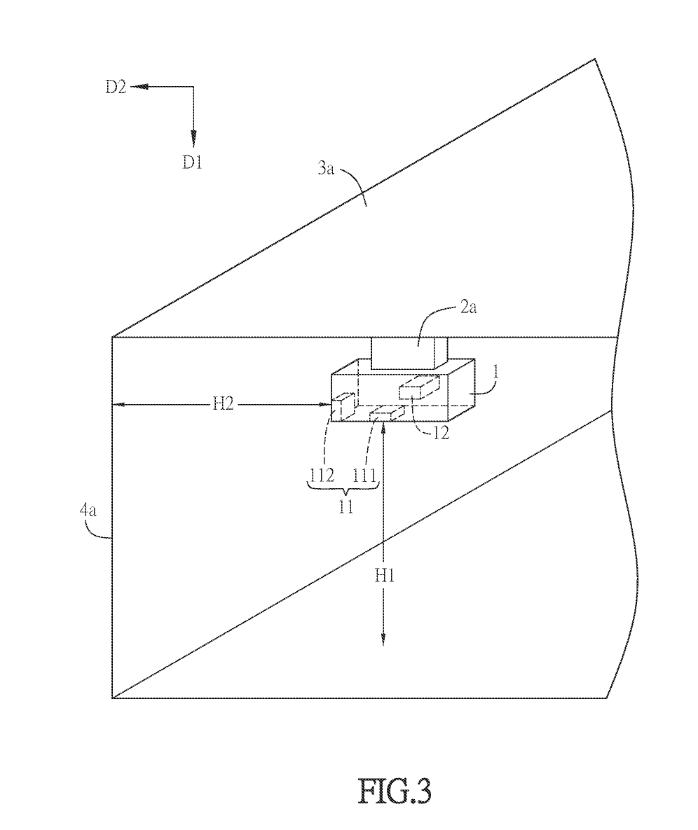

FIG. 1 is a schematic diagram of a projector according to an embodiment of the invention, and FIG. 2 is a schematic block diagram of the projector in FIG. 1. As shown in FIGS. 1 and 2, the projector 1 of this embodiment can be applied to the space where the projector 1 needs to be disposed for a long period of time, the space such as a lecture room or a conference room. In other words, the projector 1 is disposed in a particular area 2 and the frequent movement thereof is not required. Accordingly, the particular area 2 denotes the location where the projector 1 needs to be disposed and is usually the location that is better for the projection of the projector 1 on a screen. The particular area 2 can be a desktop (as shown in FIG. 1) or a ceiling (as shown in FIG. 3), and this invention is not limited thereto. The projector 1 of this embodiment includes an environment detecting module 11 and a processing module 12 that is coupled with the environment detecting module 11.

The environment detecting module 11 can detect a predetermined environmental information I_{P} at a first time and detect a real-time environmental information I_{R} at a second time. For example, the first time denotes the timing that the projector 1 is first booted after being disposed in the particular area 2, and the second time includes every timing that the projector 1 is booted after the projector 1 is disposed in the particular area 2 except the first boot-up timing. In a word, after the projector 1 is disposed in the particular area 2, the environmental information that is detected at the first boot up is regarded as the predetermined environmental information I_{P}, and the environmental information that is detected at the subsequent boot up is regarded as the real-time environmental information I_{R}. The environmental information (the predetermined environmental information I_{P} and the real-time environmental information I_{R}) denotes the location of the main body of the projector 1, so the predetermined environmental information I_{P} and the real-time environmental information I_{R} can be obtained by the environment detecting module 11 detecting the relative position between the projector 1 and other objects.

In this embodiment, the parameter of the environmental information (the predetermined environmental information I_{P} and the real-time environmental information I_{R}) includes a distance H1 (as shown in FIG. 1) between the projector 1 and a first covering object 3 along a first direction D1, so the environment detecting module 11 includes a first direction detecting unit 111 which can detect the distance H1 along the first direction D1 between the main body of the projector 1 and the first covering object 3. As mentioned above, the distance H1 detected at the first time after the projector 1 is disposed in the particular area 2 is regarded as the predetermined environmental information I_{P} and the subsequently detected distance H1 is regarded as the real-time environmental information I_{R}. Favorably, the environment detecting module 11 can further include a second direction detecting unit 112 which can detect a distance H2 along a second direction D2 between the main body of the projector 1 and a second covering object 4, and the distance H2 is regarded as another parameter of the environmental information (the predetermined environmental information I_{P} and the real-time environmental information I_{R}). The first direction D1 is different from the second direction D2, and favorably they are perpendicular to each other. The distance H1 detected by the first direction detecting unit 111 and the distance H2 detected by the second direction detecting unit 112 can be both regarded as the parameters of the predetermined environmental information I_{P} and the real-time environmental information I_{R} to acquire the more precise location of the main body of the projector 1.

The environment detecting module 11 is, for example but not limited to, an infrared distance detecting sensor or an ultrasonic distance detecting sensor, and is exemplified as an infrared distance detecting sensor in this embodiment. Accordingly, the environment detecting module 11 includes two infrared distance detecting sensors, one of which is used as the first direction detecting unit 111 to detect the distance H1 in the first direction D1 while the other is used as the second direction detecting unit 112 to detect the distance H2 in the second direction D2. The first direction detecting unit 111 and the second direction detecting unit 112 can output analog voltages in relation to the distance, and the processing module 12 can further include an analog-to-digital (A/D) converting unit 122 to convert the analog voltages into digital data for the access of a storing unit 121 and the comparison of the processing module 12.

Since the projector 1 of this embodiment is disposed on a desktop (particular area 2), the first covering object 3 can be a ceiling, the distance H1 detected by the first direction detecting unit 111 is the distance H1 between the main body of the projector 1 and the ceiling. The second covering body 4 can be a wall surface, and the distance H2 detected by the second direction detecting unit 112 is the distance H2 between the main body of the projector 1 and the wall surface. The wall surface is favorably the one which a screen 5 (as shown in FIG. 2) is disposed to, in order to ascertain that no other covering objects are disposed between the projector 1 and the second covering object 4. In other embodiments, the projector 1 also can be disposed to the ceiling, as shown in FIG. 3, which is a schematic diagram of the projector 1 in FIG. 1 disposed to another particular area. When the particular area 2a is a ceiling, the first covering object 3a can be a ground and the distance H1 detected by the first direction detecting unit 111 is the distance H1 between the main body of the projector 1 and the ground. In this case, the second covering object 4a can be still a wall surface and the distance H2 detected by the second direction detecting unit 112 is the distance H2 between the main body of the projector 1 and the wall surface. Of course, the types of the first covering object 3 (3a) and the second covering object 4 (4a) are not limited in this invention, and favorably they are immovable or commonly fixed to some object in the particular area so that the location of the projector 1 can be provided more precisely. Accordingly, in this embodiment, the predetermined environmental information I_{P} denotes the distances H1 and H2 which are detected at the first time of boot up, and the real-time environmental information I_{R} denotes the distances H1 and H2 which are detected at the subsequent times of boot up, and that means the parameter of the environmental information includes the distances H1 and H2.

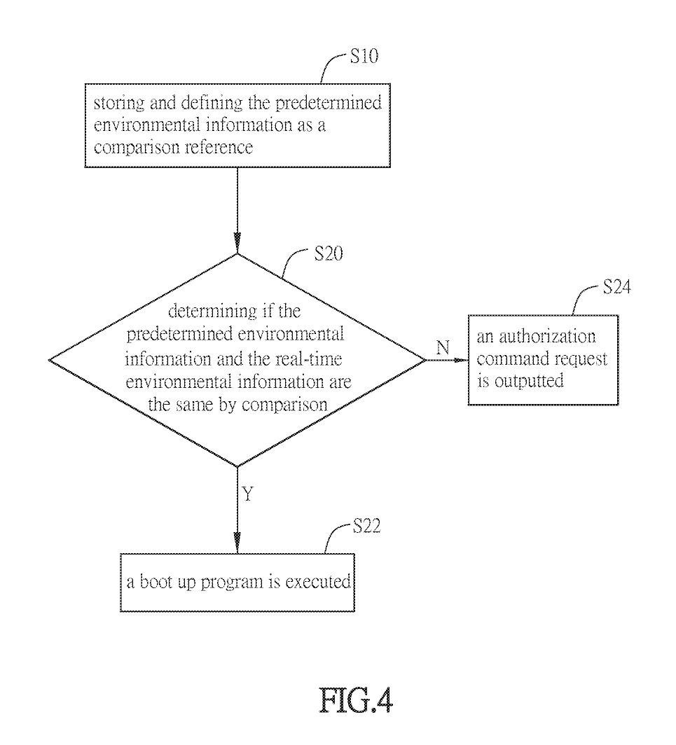

The processing module 12 can receive the predetermined environmental information I_{P} and the real-time environmental information I_{R} and executes a boot up method. FIG. 4 is a schematic flowchart of a boot up method of a projector according to an embodiment of the invention. As shown in FIG. 4, the boot up method includes the steps of: storing and defining the predetermined environmental information as a comparison reference (step S10); and determining if the predetermined environmental information and the real-time environmental information are the same by comparison (step S20), wherein when the predetermined environmental information and the real-time environmental information are substantially the same, a boot up program is executed (step S22), and when the predetermined environmental information and the real-time environmental information are substantially different, an authorization command request is outputted (step S24). As shown in FIGS. 1, 2, 4, in the step S10, the processing module 12 can store the predetermined environmental information I_{P}, so the processing module 12 favorably further includes a storing unit 121 to store the predetermined environmental information I_{P}. Since the predetermined environmental information I_{P} is the environmental information detected at the first time of boot up and also the location of the main body of the projector 1, it is a fixed value. The fixed value (the predetermined environmental information I_{P}) is stored in the storing unit 121 for serving as the comparison reference subsequently, which is defined by the processing unit 12. In other words, after the processing module 12 receives and stores the environmental information (the predetermined environmental information I_{P}) detected at the first time of boot up, the distances H1 and H2 detected at the first time of boot up are regarded as the comparison reference in this embodiment.

The step S20 is determining if the predetermined environmental information and the real-time environmental information are the same by comparison, and that means the environmental information (the real-time environmental information I_{R}) detected at the subsequent timings is compared with the predetermined environmental information I_{P}. According to the difference of the comparison result, the processing module 12 can execute different steps, i.e. the steps S22 and S24. When the predetermined environmental information I_{P} and the real-time environmental information I_{R} are substantially the same, a boot up program is executed (step S22), and when the predetermined environmental information I_{P} and the real-time environmental information I_{R} are substantially different, an authorization command request A_{R} is outputted (step S24) and the user needs to input the corresponding authorization command A. Herein, the distance detected by the first direction detecting unit 111 or the second direction detecting unit 112 may be unavoidably generated with a certain range of error, and the above mentioned “substantially the same” encompasses the error.

In detail, the predetermined environmental information I_{P} is the environmental information detected at the first time of boot up and also the location of the main body of the projector 1 disposed in the particular area 2. Hence, if the location of the projector 1 is changed after the first boot up, the environmental information (distances H1 and H2) will also be changed, so that the real-time environmental information I_{R} is different from the initial predetermined environmental information I_{P}. In this situation, an authorization command request A_{R} outputted by the processing module 12 is projected on the screen 5, and the user needs to input the corresponding authorization command A to make the projector 1 execute the boot up program. Therefore, the effectiveness of preventing theft can be achieved. Of course, in other embodiments, the projector 1 also can include a display module to display the authorization command request A_{R}. However, this invention is not limited thereto. Moreover, if the location of the projector 1 is not changed, the real-time environmental information I_{R} will be the same as the initial predetermined environmental information I_{P}. In this situation, there is no need to input the authorization command A, and the projector 1 can directly execute the boot up program (step S22) so that the boot up program can be rapidly executed. In comparison with the conventional art where the anti-theft function is provided by inputting the code before every time of boot up, this embodiment can avoid the situation that the authorization command A needs to be inputted at every time of boot up.

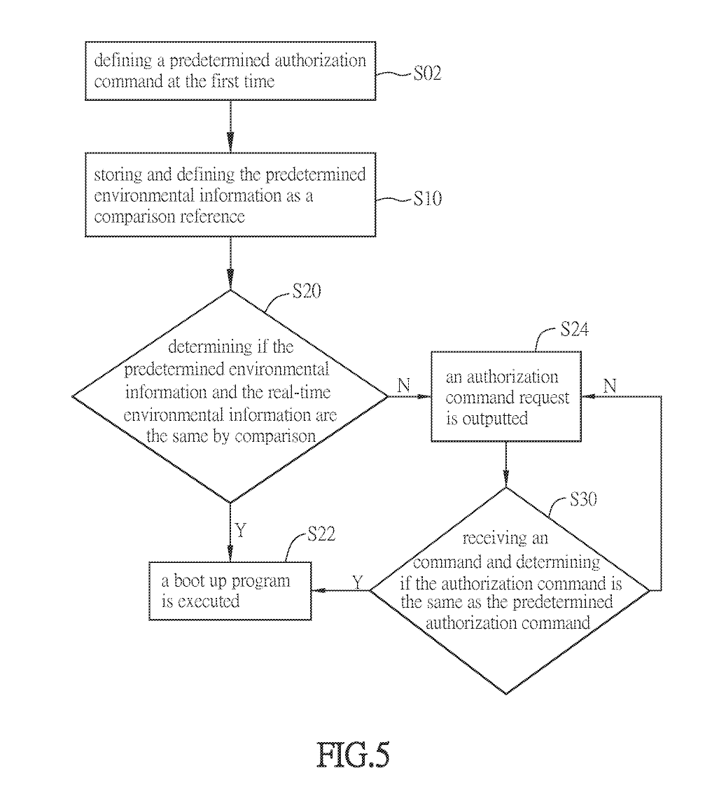

FIG. 5 is a schematic flowchart of a boot up method of a projector according to another embodiment of the invention. As shown in FIGS. 1, 2, 5, the boot up method can further include a step S02 of defining a predetermined authorization command A_{P} at the first time, and the predetermined authorization command A_{P} can encompass a particular code or gesture. In detail, the projector 1 can be connected with an input module 6, and the input module 6 is coupled with the processing module 12. The user can input a particular code or gesture by the input module 6, and the processing module 12 receives and defines the particular code or gesture as the predetermined authorization command A. Besides, the predetermined authorization command A_{P} can be stored in the storing unit 121. To be noted, the sequence of the steps S02 and S10 is not limited in this embodiment. In other words, the user can set up a particular gesture or code at the first time of the boot up of the projector 1 (the first time), and the processing module 12 defines the particular gesture or code as the predetermined authorization command A. Besides, the processing module 12 stores and defines the predetermined environmental information I_{P} detected by the environment detecting module 11 as the comparison reference. So, during the use of the projector 1, the real-time environmental information I_{R} is determined as the same as the initially defined predetermined environmental information I_{P} or not (step S20) at every time of boot up to execute the boot up program (step S22) or output the authorization command request A_{R} (step S24) that is displayed on the screen 5.

When the user sees the authorization command request A_{R} on the screen 5, the user can input an authorization command A through the input module 6. Accordingly, the boot up method executed by the processing module 12 of this embodiment can further include the step S30 of receiving an authorization command A and determining if the authorization command A is the same as the predetermined authorization command A. If the authorization command A is substantially the same as the predetermined authorization command A_{P}, the projector 1 is considered to be moved to another particular area rightly. So, if the authorization command A inputted at the subsequent boot up is substantially the same as the initial predetermined authorization command A_{P}, the processing module 12 can go back to the step S22 to normally execute the boot up program. Of course, in other embodiments, after the normal execution of the boot up program, the setting of changing the predetermined authorization command A_{P} can be executed. Moreover, the present real-time environmental information I_{R} can be stored and set as the predetermined environmental information I_{P}. In other words, when the projector 1 is moved to another particular area rightly, the present environmental information can be directly stored and defined as the new predetermined environmental information I_{P}. Accordingly, if the projector is not moved afterward, the boot up program can be directly executed. However, the invention is not limited thereto.

When the authorization command A is substantially different from the predetermined authorization command A_{P}, the processing module 12 can go back to the step S24, wherein the processing module 12 outputs the authorization command request A_{R} so that the user needs to input the right authorization command A (the same as the predetermined authorization command A_{P}) again. Therefore, the effectiveness of anti-theft can be achieved. Herein, if the authorization command A is a particular gesture, the gesture may be unavoidably generated with a certain range of error, and the above mentioned “substantially the same” encompasses the error.

A boot up method of a projector is also provided and can be directly applied to the projector, including the steps of: receiving a predetermined environmental information at a first time and storing and defining the predetermined environmental information as a comparison reference; and receiving a real-time environmental information at a second time and comparing the predetermined environmental information with the real-time environmental information, wherein when the predetermined environmental information and the real-time environmental information are substantially the same, a boot up program is executed, and when the predetermined environmental information and the real-time environmental information are substantially different, an authorization command request is outputted. The technical features of the all steps and the manner of the cooperation between the method and the components of the projector can be comprehended by referring to the above-mentioned projector 1 and the boot up method executed by the processing module 12, and therefore they are omitted here.

Summarily, in the projector and the boot up method thereof of the invention, the projector is disposed in a particular area, and the predetermined environmental information (location of the projector) is acquired at the first time of boot up (the first time) and defined as a comparison reference. Then, the real-time environmental information can be acquired at the subsequent boot up (the second time) and compared with the predetermined environmental information. If they are substantially the same, it means the projector is not moved and the boot up program can be directly executed to provide a convenient use for the user. If they are different from each other, it means the projector is moved, and an authorization command request will be outputted and the boot up program can't be executed so that the anti-theft effectiveness can be achieved.

This anti-theft manner whereby the boot up program can be directly executed when the location of the projector is not changed and the corresponding authorization command needs to be inputted only when the location is changed is convenient for the user's operation, and also eliminates the inconvenience of the conventional art where the authorization command needs to be inputted for the unlocking at every time of using the projector. Moreover, because the predetermined environmental information and the real-time environmental information are acquired by the environment detecting module of the projector, there is no need to add the component that will affect the appearance of the projector, and therefore not only the anti-theft effectiveness is achieved but also the completeness of the appearance of the projector is kept.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A projector, comprising:
an environment detecting module detecting a predetermined environmental information at a first time and a real-time environmental information at a second time; and
a processing module coupled to the environment detecting module, and receiving the predetermined environmental information and the real-time environmental information and executing a boot up method, the boot up method including the steps of:
storing and defining the predetermined environmental information as a comparison reference; and
comparing the predetermined environmental information with the real-time environmental information,
wherein when the predetermined environmental information and the real-time environmental information are substantially the same, a boot up program is executed, and when the predetermined environmental information and the real-time environmental information are substantially different, an authorization command request is outputted.

2. The projector as recited in claim 1, wherein the first time denotes the timing of the first boot-up of the projector after the projector is disposed in a particular area.

3. The projector as recited in claim 1, wherein the second time denotes another timing of the projector after the projector is disposed in a particular area except the timing of the first boot-up of the projector.

4. The projector as recited in claim 1, wherein the boot up method further includes a step of:
defining a predetermined authorization command at the first time.

5. The projector as recited in claim 1, wherein the boot up method further includes a step of:
receiving an authorization command and comparing the authorization command with the predetermined authorization command.

6. The projector as recited in claim 5, wherein when the authorization command and the predetermined authorization command are substantially the same as each other, the processing module executes the boot up program.

7. The projector as recited in claim 5, wherein when the authorization command is substantially different from the predetermined authorization command, the processing module outputs the authorization command request.

8. The projector as recited in claim 1, wherein the environment detecting module includes a first direction detecting unit detecting a distance between the projector and a first covering object along a first direction.

9. The projector as recited in claim 8, wherein the environment detecting module includes a second direction detecting unit detecting a distance between the projector and a second covering object along a second direction that is different from the first direction.

10. The projector as recited in claim 1, wherein the environment detecting module includes an infrared distance detecting sensor or an ultrasonic distance detecting sensor.

11. The projector as recited in claim 1, wherein the processing module further includes a storing unit storing the predetermined environmental information and the predetermined authorization command.

12. A boot up method of a projector, comprising the steps of:
receiving a predetermined environmental information at a first time and storing and defining the predetermined environmental information as a comparison reference; and
receiving a real-time environmental information at a second time and comparing the predetermined environmental information with the real-time environmental information,
wherein when the predetermined environmental information and the real-time environmental information are substantially the same, a boot up program is executed, and when the predetermined environmental information and the real-time environmental information are substantially different, an authorization command request is outputted.

13. The boot up method of a projector as recited in claim 12, wherein the first time denotes the timing of the first boot-up of the projector after the projector is disposed in a particular area.

14. The boot up method of a projector as recited in claim 12, wherein the second time denotes another timing of the projector after the projector is disposed in a particular area except the timing of the first boot-up of the projector.

15. The boot up method of a projector as recited in claim 12, further comprising a step of:
defining a predetermined authorization command at the first time.

16. The boot up method of a projector as recited in claim 15, further comprising a step of:
receiving an authorization command and comparing the authorization command with the predetermined authorization command.

17. The boot up method of a projector as recited in claim 16, wherein when the authorization command and the predetermined authorization command are substantially the same as each other, the boot up program is executed.

18. The boot up method of a projector as recited in claim 16, wherein when the authorization command is substantially different from the predetermined authorization command, the authorization command request is outputted.

19. The boot up method of a projector as recited in claim 12, wherein the predetermined environmental information and the real-time environmental information include a distance between the projector and a first covering object along a first direction.

20. The boot up method of a projector as recited in claim 19, wherein the predetermined environmental information and the real-time environmental information further include a distance between the projector and a second covering object along a second direction, and the first direction is different from the second direction.
